(19) United States
(12) Patent Application Publication
(10) Pub. No.: US 2022/0394388 A1
(43) Pub. Date: Dec. 8, 2022

(54) SPEAKER

(71) Applicant: Acer Incorporated, New Taipei City (TW)

(72) Inventor: Jia-Ren CHANG, New Taipei City (TW)

(21) Appl. No.: 17/505,752

(22) Filed: Oct. 20, 2021

(30) Foreign Application Priority Data
Jun. 2, 2021 (TW) 110119969

(51) Int. Cl. H04R 9/02; H04R 7/22

(52) U.S. Cl. CPC H04R 9/02; H04R 7/22

(57) ABSTRACT

A speaker includes a supporting base, a first speaker assembly and a second speaker assembly. The first speaker assembly includes a first magnet, a first coil and a first diaphragm. The first magnet is disposed on the carrier. The first coil is configured to interact with the first magnet. The first diaphragm is connected to the first coil. The second speaker assembly includes a second magnet, a second coil and a second diaphragm. The second magnet is disposed on the carrier. The second coil is configured to interact with the second magnet. The second diaphragm is connected to the second coil. The first speaker assembly and the second speaker assembly are symmetrical relative to the carrier such that, in operation, the magnitudes of the displacement of the first diaphragm and the second diaphragm are the same, but the directions of the displacement are opposite.

This application claims the benefit of Taiwan Application Serial No. 110119969, filed June 2, 2021, the subject matter of which is incorporated herein by reference in its entirety.

### TECHNICAL FIELD

The present invention is directed to an audio speaker with improved vibration characteristics.

### BACKGROUND

Generally speaking, electronic devices, such as notebook computers, are equipped with at least one speaker module configured to emit sound. However, conventional speaker modules tend to generate unnecessary vibrations when they emit sound, and those vibrations may detrimentally interact with the casing of the notebook computer resulting in unintended noise, thereby affecting the overall sound effect of the speakers.

There is, accordingly, a need to design a speaker that can reduce or eliminate unintended and detrimental vibration.

### SUMMARY

In accordance with an embodiment, an audio speaker is provided. The speaker includes a carrier, a first speaker assembly and a second speaker assembly. The first speaker assembly includes a first magnet, a first coil, and a first diaphragm. The first magnet is disposed on the carrier. The first coil is configured to interact with the first magnet. The first diaphragm is connected to the first coil. The second speaker assembly includes a second magnet, a second coil, and a second diaphragm. The second magnet is disposed on the carrier. The second coil is configured to interact with the second magnet. The second diaphragm is connected to the second coil. The first speaker assembly and the second speaker assembly are symmetrical relative to the carrier. The first coil and the second coil are configured to receive a current so that the first coil drives the first diaphragm and the second coil drives the second diaphragm to move at the same time. The magnitudes of the displacement of the first diaphragm and the second diaphragm are the same, but the directions of the displacement of the first diaphragm and the second diaphragm are opposite.

### BRIEF DESCRIPTION OF THE DRAWINGS

Embodiments are described herein in conjunction with the accompanying drawings, in which:

FIG. 1 is a perspective view of a speaker according to an example embodiment of the present invention.

FIG. 2 is an exploded view of the speaker of FIG. 1 according to an example embodiment of the present invention.

FIG. 3 is a schematic cross-sectional view of the speaker along the section line A-A in FIG. 1 according to an example embodiment of the present invention.

FIG. 4 shows a graph of a relationship between frequency and displacement of the speaker according to an example embodiment of the present invention.

FIG. 5 is a top view of a part of the structure of the speaker according to an example embodiment of the present invention.

FIG. 6 is a bottom view of a part of the structure of the speaker according to an example embodiment of the present invention.

FIG. 7 is a front view of the speaker according to an example embodiment of the present invention.

FIG. 8 is a top view of the first diaphragm according to an example embodiment of the present invention.

FIG. 9 and FIG. 10 are schematic top views of the first diaphragm according to alternative example embodiments of the present invention.

### DESCRIPTION OF EXAMPLE EMBODIMENTS

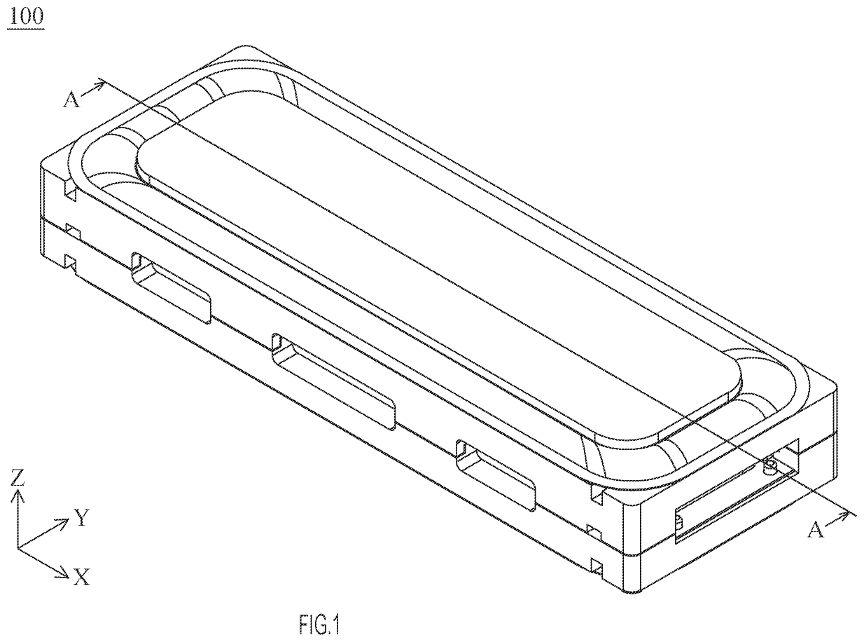

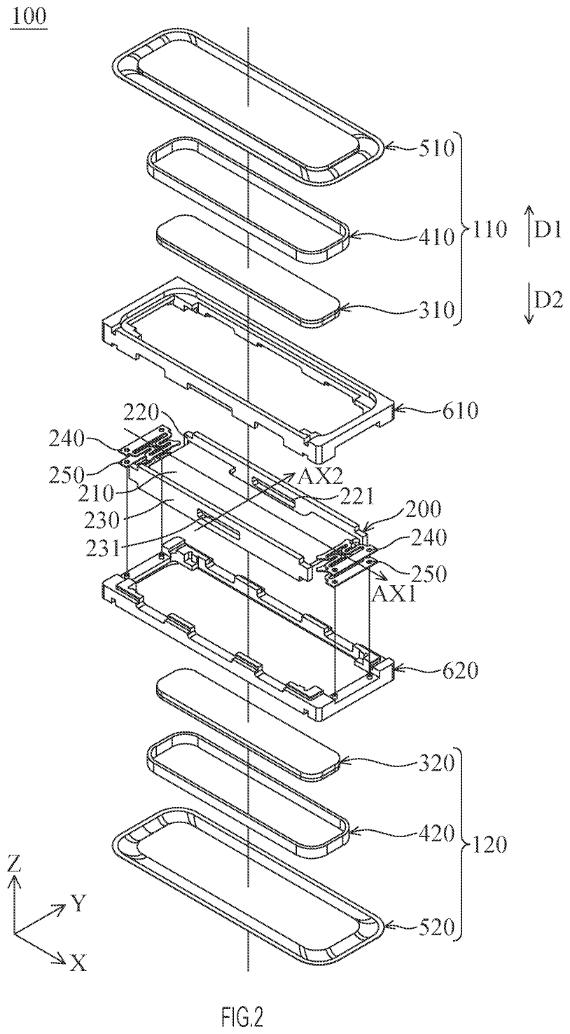

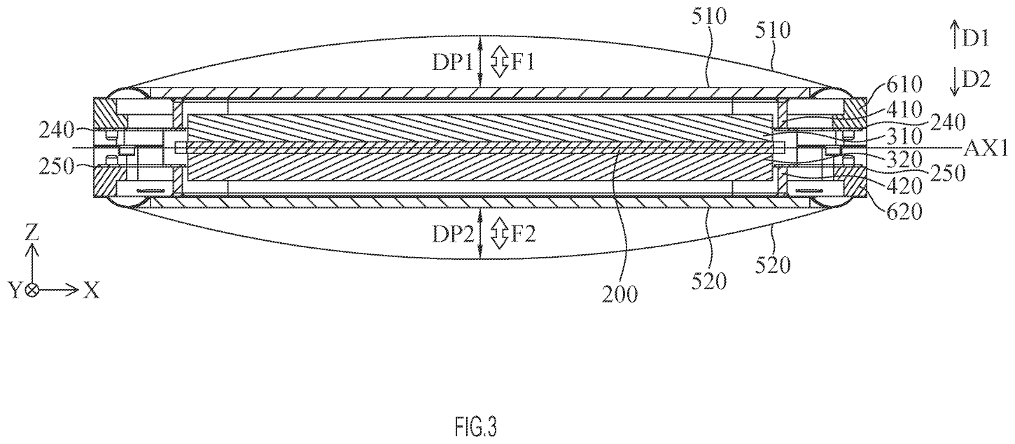

Reference is now made to FIG. 1, FIG. 2, and FIG. 3. FIG. 1 is a perspective view of a speaker 100 according to an example embodiment of the present invention. FIG. 2 is an exploded view of the speaker 100 of FIG. 1 according to an example embodiment of the present invention. And, FIG. 3 is a schematic cross-sectional view of the speaker 100 along the section line A-A in FIG. 1 according to an example embodiment of the present invention.

In this embodiment, the speaker 100 may include a carrier 200, a first speaker assembly 110 and a second speaker assembly 120. The second speaker assembly 120, the carrier 200, and the first speaker assembly 110 are sequentially arranged along a first direction D1. Specifically, as shown in FIG. 2 and FIG. 3, the first speaker assembly 110 and the second speaker assembly 120 are symmetrically arranged on the upper and lower sides of the carrier 200.

The first speaker assembly 110 includes a first magnet 310, a first coil 410, and a first diaphragm 510. The first magnet 310 is fixedly arranged on the carrier 200, the first coil 410 is arranged to interact with the first magnet 310, and the first diaphragm 510 is fixedly connected to one side of the first coil 410.

Similarly, the second speaker assembly 120 includes a second magnet 320, a second coil 420, and a second diaphragm 520. The second magnet 320 is fixedly disposed on the carrier 200, the second coil 420 is arranged to interact with the second magnet 320, and the second diaphragm 520 is fixedly connected to one side of the second coil 420.

The speaker 100 may further include a first frame 610 and a second frame 620. The first frame 610 is fixed to the second frame 620 via, e.g., glue, to hold the carrier 200 therebetween. In one possible implementation, the first frame 610, the second frame 620, and the carrier 200 may be made of plastic material. Furthermore, the first frame 610 and the second frame 620 may be configured to clamp the first diaphragm 510 and the second diaphragm 520, respectively.

It should be noted that the first speaker assembly 110 and the second speaker assembly 120, to the extent possible, are the same size, are composed of the same material, and exhibit the same parameters or properties. Specifically, the first magnet 310 and the second magnet 320 are preferably manufactured from the same elemental material and have the same permeability coefficient, the first coil 410 and the second coil 420 have the same number of windings and winding length, and the first diaphragm 510 is manufactured using the same material as the second diaphragm 520.

Therefore, when the first coil 410 and the second coil 420 receive a current, e.g., an alternating current, the first magnet 310 and the first coil 410 will induce a first electromagnetic driving force F1, as shown in FIG. 3. The electromagnetic driving force F1 causes the first coil 410 to drive the first diaphragm 510 to displace. The second magnet 320 and the second coil 420 generate a second electromagnetic driving force F2. The second electromagnetic driving force F2 causes the second coil 420 to drive the second diaphragm 520 to displace. In accordance with an embodiment, the displacement of the first diaphragm 510 and the displacement of the second diaphragm 520 have the same magnitude, but opposite directions.

For example, assume the waveform of the current is a sine wave. When the phase of the current is 0 to 180 degrees, the first diaphragm 510 generates a first displacement DP1 along the first direction D1, and the second diaphragm 520 generates a second displacement DP2 along a second direction D2. Conversely, when the phase of the current is 180 to 360 degrees, the first diaphragm 510 generates a first displacement DP1 along the second direction D2, and the second diaphragm 520 generates a second displacement DP2 along the first direction D1. In this embodiment, the first electromagnetic driving force Fl and the second electromagnetic driving force F2 have the same magnitude, so the first displacement DP1 and the second displacement DP2 have the same magnitude, but in opposite directions.

In addition, the first coil 410 is connected in parallel with the second coil 420 so that the phases of the currents received by the first coil 410 and the second coil 420 are the same at the same point in time.

Based on the above design, when the speaker 100 receives the current, the first electromagnetic driving force F1 and the second electromagnetic driving force F2 urge the first diaphragm 510 and the second diaphragm 520 to vibrate with the same magnitude and opposite direction. As a result, therefore, the carrier 200 is not, or is very minimally, affected by the above-mentioned electromagnetic driving forces. That is, the carrier 200 will not move on the Z axis when the speaker 100 emits sound.

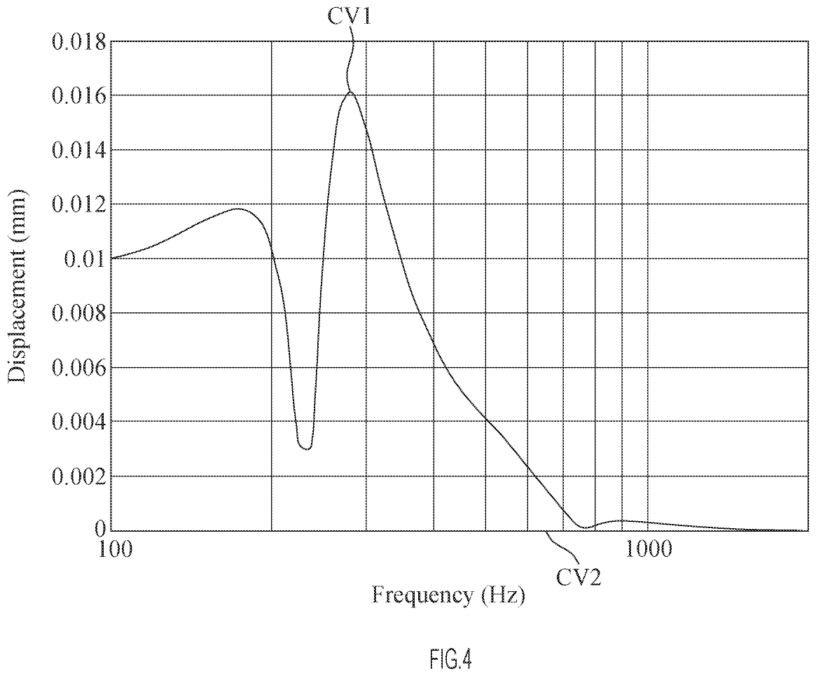

Reference is next made to FIG. 4, which is a graph of the relationship between frequency and displacement of the speaker 100 according to an embodiment of the present invention in comparison to a conventional speaker. As shown in FIG. 4, the curve CV1 represents the displacement curve in the Z-axis direction when a conventional speaker emits sounds of different frequencies, and the straight line CV2 represents the displacement in the Z-axis direction when the speaker 100 of the present invention emits sounds of different frequencies.

As shown in FIG. 4, the displacement of the conventional speaker in the Z-axis direction at multiple frequencies is greater than zero. That is, the conventional speaker vibrates when it emits sound. In contrast, the displacement of the speaker 100 of the present invention at different frequencies is zero. Therefore, when the speaker 100 of the present invention emits sound, it does not generate unwelcome vibration like a conventional speaker.

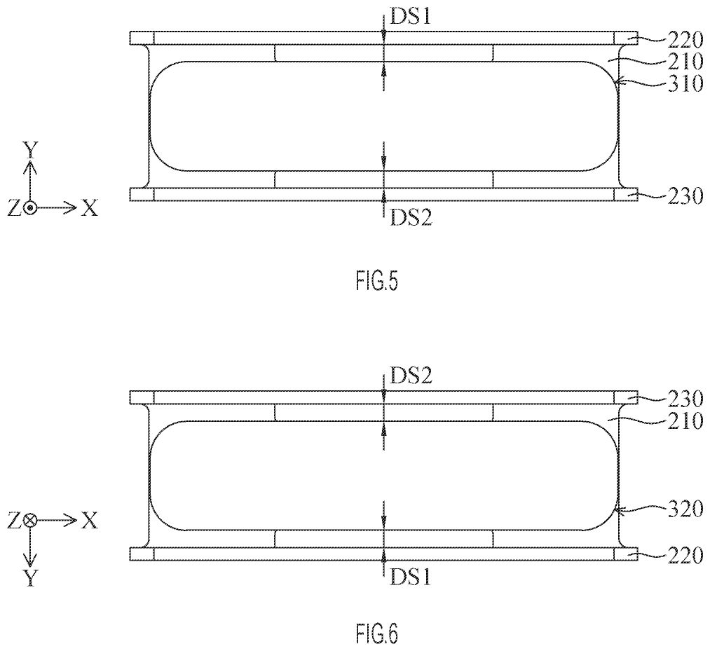

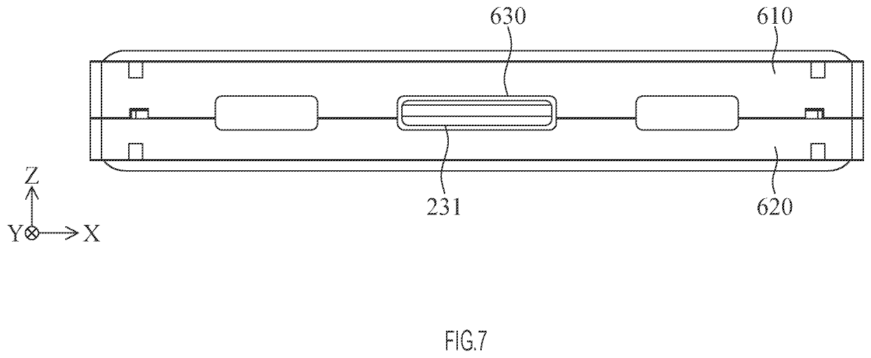

Next, reference is still made to FIG. 2, and now also to FIG. 5 and FIG. 6. FIG. 5 is a top view of a part of the structure of the speaker 100 according to an embodiment of the present invention, and FIG. 6 is a bottom view of a part of the structure of the speaker 100 according to an embodiment of the present invention. The carrier 200 may have a bottom plate 210, a side wall 220, and a side wall 230, and the first magnet 310 and the second magnet 320 are fixed on opposite sides of the bottom plate 210.

Furthermore, as shown in FIG. 5, when viewed along the first direction D1 Z-axis, the distance DS1 between the side wall 220 and the first magnet 310 in the Y-axis direction is equal to the distance between the side wall 230 and the first magnet 310 in the Y-axis direction DS2. Similarly, as shown in FIG. 6, the distance DS2 between the side wall 230 and the second magnet 320 in the Y-axis direction is equal to the distance DS1 between the side wall 220 and the second magnet 320 in the Y-axis direction.

Based on the aforementioned structural design, the first magnet 310 and the second magnet 320 can have the same magnetic circuit, thereby ensuring that the first speaker assembly 110 and the second speaker assembly 120 generate the same electromagnetic driving force.

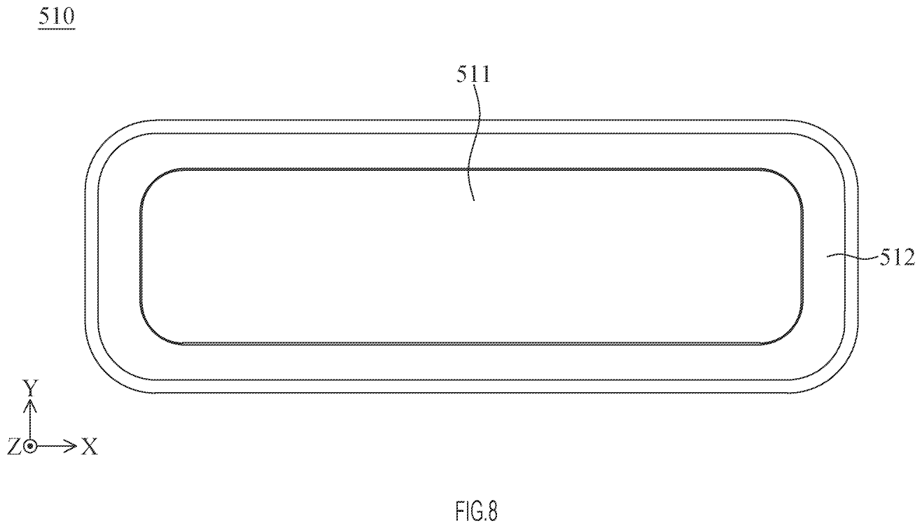

Reference is now made to FIG. 1 and FIG. 2, and also to FIG. 7. FIG. 7 is a front view of the speaker 100 according to an embodiment of the present invention. In this embodiment, the carrier 200 may define a first axis AX1 and a second axis AX2, a vent hole 221 may be formed in the side wall 220, a vent hole 231 may be formed in the side wall 230, and the vent hole 221 is connected to the vent hole 231. The vent holes 221 and 231 are arranged along the second axis AX2 and are symmetrical to the first axis AX1 and the second axis AX2.

In addition, the first frame 610 and the second frame 620 may be jointly formed with a plurality of through holes 630, corresponding to the aforementioned vent holes 221 and 231. For example, the first frame 610 and the second frame 620 may be jointly formed with six through holes 630, which are equally arranged on opposite sides of the speaker 100. Furthermore, as shown in FIG. 7, when viewed along the second axial direction AX2 Y-axis, the through hole 630 in the middle overlaps the vent hole 231.

Based on the design of the aforementioned vent holes 221 and 231 and through holes 630 symmetrical to the first axis AX1, it can be ensured that when the first diaphragm 510 and the second diaphragm 520 vibrate, air can be uniformly discharged from the speaker 100, so that the speaker 100 does not generate vibration in the Z-axis direction.

Furthermore, in this embodiment, as shown in FIG. 2 and FIG. 3, the carrier 200 may further include two first cantilevers 240 and two second cantilevers 250, and the two first cantilevers 240 are connected to the first coil 410 and the first frame 610, and the two second cantilevers 250 are connected to the second coil 420 and the second frame 620. Furthermore, the first coil 410 is electrically connected to the two first cantilevers 240, and the second coil 420 is electrically connected to the two second cantilevers 250, and the two first cantilevers 240 and the two second cantilevers 250 function as suspension for the first coil 410 and the second coil 420, respectively.

In the embodiment shown, the two first cantilevers 240 and the two second cantilevers 250 are symmetrical to the first axis AX1, the two first cantilevers 240 are symmetrical to the second axis AX2, and the two second cantilevers 250 are symmetrical in the second axis AX2. Furthermore, in some embodiments, the first cantilever 240 and the second cantilever 250 can be connected to an external housing not shown in the figure, such as the inner wall surface of a housing of the speaker 100, so that the speaker 100 is suspended in the shell.

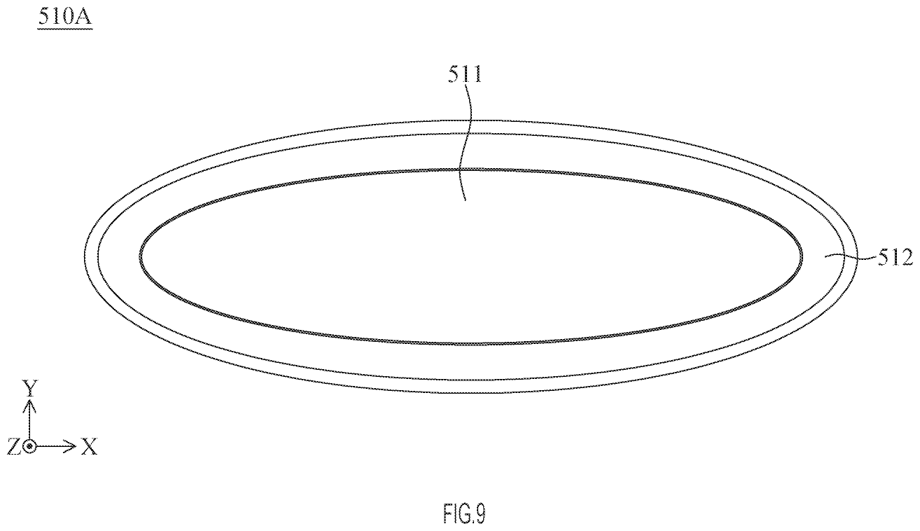

FIG. 8 is a top view of the first diaphragm 510 according to an embodiment of the present invention. In this embodiment, the first diaphragm 510 has an inner portion 511 and an outer portion 512. The outer portion 512 surrounds the inner portion 511, and the hardness of the inner portion 511 is higher than that of the outer portion 512. For example, the inner portion 511 may be made of paper, carbon fiber or metal materials, and the outer portion 512 may be made of foam or plastic materials. As for the second diaphragm 520, its structure and materials are the same as those of the first diaphragm 510.

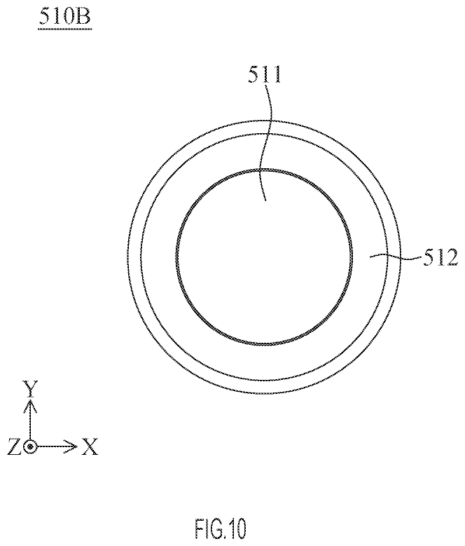

FIG. 9 and FIG. 10 are schematic top views of the first diaphragm 510 according to different embodiments of the present disclosure. In accordance with an embodiment, the shape of the first diaphragm 510 and the second diaphragm 520 is not limited to the substantially rectangular shape depicted thus far.

For example, as shown in FIG. 9, a first diaphragm 510A may have an elliptical structure, and, as shown in FIG. 10, a first diaphragm 510B may have a circular structure. The first diaphragm 510A and the first diaphragm 510B can be used in speaker designs of different shapes.

In summary, the present invention provides a speaker 100, which includes a carrier 200 and a pair of speaker assemblies, namely a first speaker assembly 110 and a second speaker assembly 120. The first speaker assembly 110 and the second speaker assembly 120 are symmetrical to the carrier 200, and the first speaker assembly 110 and the second speaker assembly 120 have the same size, are made from the same material, and exhibit the same parameters or properties.

Therefore, when the speaker 100 receives current representing an audio signal, the first electromagnetic driving force F1 and the second electromagnetic driving force F2 that drive the first diaphragm 510 and the second diaphragm 520 vibrate the first diaphragm 510 and the second diaphragm 520 with the same magnitude, but opposite directions. As a result, the carrier 200 is not be affected by the aforementioned electromagnetic driving force. That is, the carrier 200 will not vibrate, or will only minimally vibrate, in the Z axis when the speaker 100 emits sound.

Based on the design of the present invention, when the speaker 100 receives a current signal to emit sound, the speaker 100 does not produce any significant displacement in the Z-axis direction. Therefore, when the speaker 100 is installed in an electronic device such as a tablet computer or a smart phone, etc., it will not cause vibration and noise that can detrimentally affect the sound output by the speaker 100.

The above description is intended by way of example only.

What is claimed is:

1. A speaker, comprising:
a carrier;
a first speaker assembly disposed on a first side of the carrier, the first speaker assembly including a first magnet fixedly arranged on the first side of the carrier, a first coil arranged to interact with the first magnet, and a first diaphragm fixedly connected to the first coil;
a second speaker assembly disposed on a second side of the carrier, opposite to the first side of the carrier, the second speaker assembly including a second magnet fixedly arranged on the second side of the carrier, a second coil arranged to interact with the second magnet, and a second diaphragm fixedly connected to the second coil.

2. The speaker of claim 1, wherein the first magnet and the second magnet are comprised of a same elemental material, the first coil and the second coil have a same number of turns, and the first diaphragm and the second diaphragm are made of a same material.

3. The speaker of claim 1, further comprising a first frame and a second frame arranged to hold the carrier therebetween.

4. The speaker of claim 3, wherein the carrier, the first frame, and the second frame are comprised of plastic.

5. The speaker of claim 3, wherein the first frame and the second frame clamp the first diaphragm and the second diaphragm, respectively, to the carrier.

6. The speaker of claim 3, further comprising at least one cantilever extending from each of the first frame and the second frame, and supporting, respectively, the first coil and the second coil.

7. The speaker of claim 1, wherein the carrier comprises a bottom plate, a first side wall and a second side wall, and wherein the first magnet and the second magnet are fixed on opposite sides of the bottom plate.

8. The speaker of claim 7, wherein a distance between an edge of the first side wall and the first magnet is equal to a distance between an edge of the second side wall and the second magnet.

9. The speaker of claim 7, wherein the first side wall defines a first vent hole and the second side wall defines a second vent hole.

10. The speaker of claim 9, wherein the first vent hole and the second vent hole are symmetrical with respect to each other.

11. The speaker of claim 1, wherein, in operation, a displacement of the first diaphragm and a displacement of the second diaphragm have a same magnitude, but opposite direction.

12. The speaker of claim 1, wherein, in operation, the carrier is not displaced when the first diaphragm and the second diaphragm are displaced.

13. A speaker, comprising:
a carrier;
a first speaker assembly disposed on a first side of the carrier, the first speaker assembly including a first diaphragm; and
a second speaker assembly disposed on a second side of the carrier, opposite the first side of the carrier, the second speaker assembly including a second diaphragm,
wherein in operation of the speaker, a displacement of the first diaphragm and a displacement of the second diaphragm have a same magnitude, but opposite direction.

14. The speaker of claim 13, wherein, in operation, the carrier is not displaced when the first diaphragm and the second diaphragm are displaced.

15. The speaker of claim 13, further comprising a first frame and a second frame arranged to hold the carrier therebetween.

16. The speaker of claim 13, wherein the carrier comprises a bottom plate, a first side wall and a second side wall, the first speaker assembly includes a first magnet, the second speaker assembly includes a second magnet, and the first magnet and the second magnet are fixed on opposite sides of the bottom plate.

17. The speaker of claim 16, wherein a distance between an edge of the first side wall and the first magnet is equal to a distance between an edge of the second side wall and the second magnet.

18. The speaker of claim 16, wherein the first side wall defines a first vent hole and the second side wall defines a second vent hole.

19. The speaker of claim 18, wherein the first vent hole and the second vent hole are symmetrical.

20. The speaker of claim 13, wherein the first speaker assembly further comprises a first magnet and a first coil, the second speaker assembly further comprises a second magnet and a second coil, and the first magnet and the second magnet are comprised of a same elemental material, the first coil and the second coil have a same number of turns, and the first diaphragm and the second diaphragm are made of a same material.
